(19) United States
(12) Patent Application Publication
(10) Pub. No.: US 2007/0172755 A1
(43) Pub. Date: Jul. 26, 2007

(54) Positive photoresist and method for producing structure

(76) Inventors: Masanori Nakamura, Ibaraki (JP); Nobuhiro Mori, Ibaraki (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/579,902

(22) PCT Filed: Nov. 17, 2004
(86) PCT No.: PCT/JP04/17053

§ 371 Date: Feb. 9, 2007

(30) Foreign Application Priority Data
Nov. 21, 2003 (JP) 2003-392912
May 20, 2004 (JP) 2004-150545

(51) Int. Cl. G03C 1/00

(52) U.S. Cl. 430/270.1

(57) ABSTRACT

Disclosed herein are a positive-type photoresist which can be developed with an aqueous alkali solution of low concentration or neutral water, can be readily stripped with ozone water, hardly produces scum, and contributes to reduction in costs and environmental loads, and a method for manufacturing a structure having a circuit formed using a resist pattern of the photoresist. A positive-type photoresist comprising a novolac resin having a benzene nucleus to which two or more hydroxyl groups are bonded and a weight-average molecular weight of 1,000 to 20,000. A method for manufacturing a structure having a circuit formed using as a resist pattern the positive-type photoresist comprising the steps of forming a resist film on the surface of a substrate by the use of the positive-type photoresist, exposing the resist film to light and carrying out development, forming a circuit using the resist pattern, and removing the resist film.

### TECHNICAL FIELD

The present invention relates to a positive-type photoresist for use in manufacturing, for example, semiconductors or LCDs. More particularly, the present invention relates to a positive-type photoresist containing a novolac resin and a method for manufacturing a structure by the use of the positive-type photoresist.

### BACKGROUND ART

Photolithography using photoresists is widely used in manufacturing semiconductors or LCDs. In the meantime, if a photoresist can be stripped with ozone water, it is possible to reduce environmental loads as well as to simplify the process of stripping a photoresist.

In order to allow a photoresist to be readily stripped with ozone water, a resin constituting the photoresist have to be hydrophilic. However, in a case where a hydrophilic resist resin is used, there is a possibility that resolution becomes low due to the swelling of the resist resin during development. Therefore, it can be considered that the resist resin preferably has a functional group which is not originally hydrophilic but becomes hydrophilic by carrying out some kind of treatment.

However, a photoresist resin which can be stripped with ozone water has not been heretofore considered particularly.

Though not intended for use as an ozone water-strippable photoresist resin, there is known a photoresist resin in which a hydrophilic group is capped with another functional group. For example, Japanese Patent Laid-open No. 2001-183838 discloses a positive-type chemically amplified photosensitive resin comprising a novolac resin having a structure in which a hydroxyl group bonded to a benzene ring is capped with an acetal group or the like. However, capping using an acetal group or the like cannot be removed by treatment with ozone water, and therefore the novolac resin disclosed in Japanese Patent Laid-open No. 2001-183838 is not suitable for use as an ozone water-strippable photoresist resin. In order to allow the novolac resin disclosed in Japanese Patent Laid-open No. 2001-183838 to have hydrophilicity, it is necessary to expose the novolac resin to light to generate acid to remove capping with the acid. Further, the novolac resin disclosed in Japanese Patent Laid-open No. 2001-183838 does not have a benzene ring to which two or more hydroxyl groups are bonded.

There are not many examples of a novolac resin having a benzene nucleus containing two or more hydroxyl groups in the molecular chain. This is because it is very difficult to obtain such a novolac resin by polymerization. Further, there is a problem that a positive-type photoresist comprising such a novolac resin is so hydrophilic that it is not suitable for use as a photoresist.

For this reason, a novolac resin for use in a positive-type photoresist is usually prepared by using phenol, cresol, or xylenol containing one hydroxyl group as a raw material, as described in Japanese Patent Laid-open No. 2001-183838. Such a novolac resin is not readily dissolved in weak alkaline water, and therefore it is necessary to use strong alkaline water such as a 2.38 wt % aqueous tetramethylammonium hydroxide solution to carry out development, thus resulting in high costs of chemicals and wastewater treatment.

Further, as described above, since such a novolac resin is not completely degraded with ozone water, it is necessary to use a cleaning agent which is not good for the environment, such as organic solvents, acids, or alkalis to degrade the novolac resin.

Furthermore, heretofore there has been a strong demand for a positive-type photoresist which hardly produces scum that is a residue of a photoresist remaining after development. However, it has been difficult to meet the demand while ensuring other performance.

### DISCLOSURE OF THE INVENTION

It is therefore an object of the present invention to provide a positive-type photoresist which is excellent in heat resistance, sensitivity, and resolution, can be developed with a weak aqueous alkali solution and well degraded with ozone water, and hardly produces scum that is a residue of the resist remaining after development, and a method for manufacturing a structure having a resist pattern formed using the positive-type photoresist.

A positive-type photoresist according to the present invention comprises, as constitution component, a novolac resin having a benzene nucleus containing two or more hydroxyl groups and a weight-average molecular weight of 1,000 to 20,000 and/or a derivative thereof.

In the positive-type photoresist according to the present invention, it is preferred that the novolac resin has a benzene nucleus represented by any one of the following formulas (1) to (6) each containing two or more hydroxyl groups: 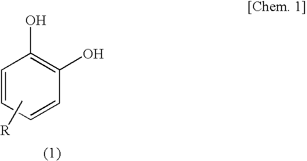 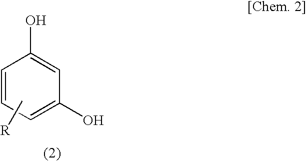 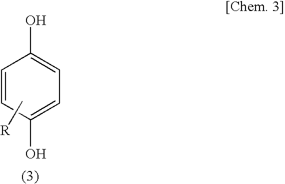 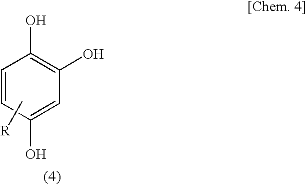 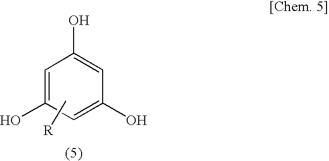 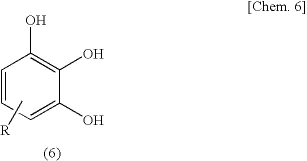
where R in each of the formulas (1) to (6) represents a hydrogen atom or a lower alkyl group having 6 or less carbon atoms.

In a specific aspect of the positive-type photoresist according to the present invention, the novolac resin is obtained by alternating copolymerization of at least two kinds of monomers.

In another specific aspect of the positive type-photoresist according to the present invention, the novolac resin is obtained by alternating copolymerization of at least one kind of monomers represented by the following formulas (7) to (16) and at least one kind of monomers represented by the following formulas (17) to (26), wherein at least one kind of monomers represented by the following formulas (7), (8), (17), and (18) each containing two or more hydroxyl groups is used as the monomer for alternating copolymerization:

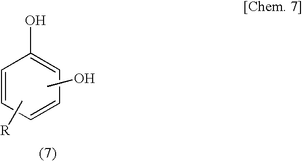

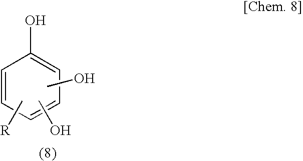

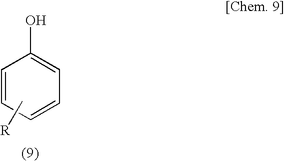

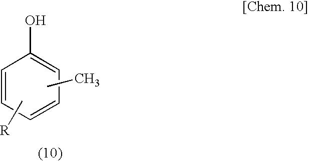

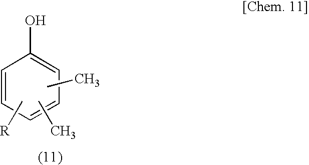

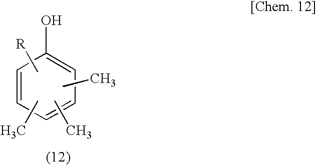

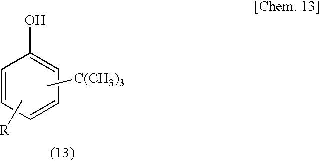

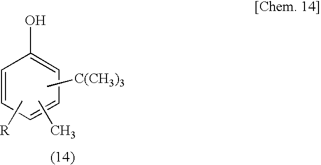

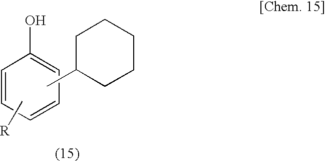

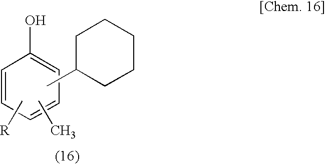

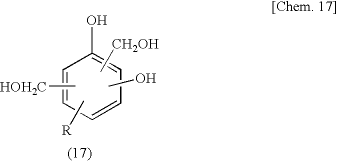

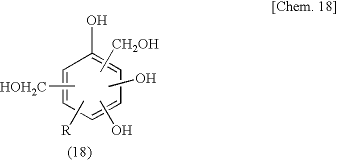

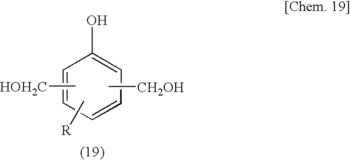

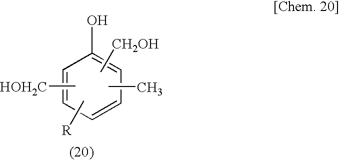

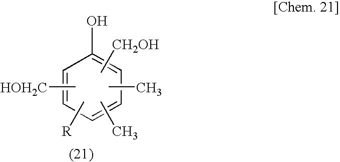

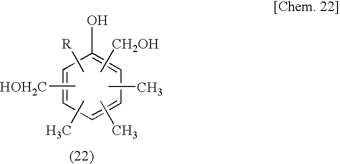

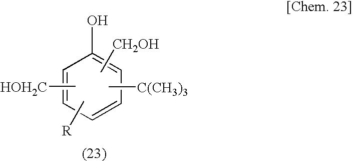

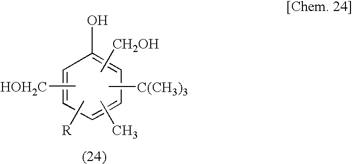

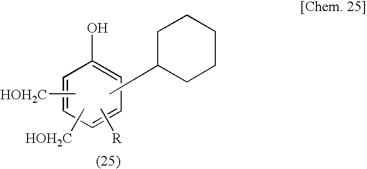

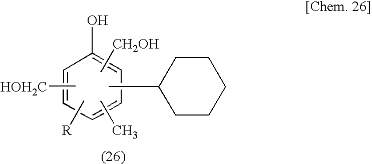

where R in each of the formulas (7) to (26) represents a hydrogen atom or a lower alkyl group having 6 or less carbon atoms.

In still another specific aspect of the positive-type photoresist according to the present invention, 30 parts by weight or more of total amount of the monomers represented by the formulas (7), (8), (17), and (18) each containing two or more hydroxyl groups is used with respect to 100 parts by weight of total amount of the monomers represented by the formulas (7) to (16) and the monomers represented by the formulas (17) to (26).

In a specific aspect of the positive-type photoresist according to the present invention, a derivative of the novolac resin is obtained by replacing some of the hydroxyl groups of the novolac resin with a substituent.

In a more specific aspect of the positive-type photoresist according to the present invention, some of the hydroxyl groups of the novolac resin are esterified and/or etherified.

In another specific aspect of the positive-type photoresist according to the present invention, the replacement of some of the hydroxyl groups with a substituent is carried out using at least one compound selected from the group consisting of alkyl ethers, aryl ethers, benzyl ethers, triaryl methyl ethers, trialkylsilyl ethers, and tetrahydropyranyl ethers.

In still another specific aspect of the positive-type photoresist according to the present invention, the replacement of some of the hydroxyl groups with a substituent is carried out using at least one compound selected from the group consisting of acetate, benzoate, methanesulfonic acid esters, and benzenesulfonic acid esters.

In a specific aspect of the positive-type photoresist according to the present invention, a photosensitive compound is mixed with the novolac resin and/or a derivative of the novolac resin.

In a more specific aspect of the positive-type photoresist according to the present invention, 5 to 50 parts by weight of the photosensitive compound is mixed with 100 parts by weight of total amount of the novolac resin and a derivative of the novolac resin.

In a specific aspect of the positive-type photoresist according to the present invention, a derivative of the novolac resin is a photosensitive novolac resin obtained by reacting the novolac resin with a photosensitive compound.

In the positive-type photoresist according to the present invention, it is preferred that the photosensitive novolac resin is obtained by reacting 5 to 50 parts by weight of a photosensitive compound with 100 parts by weight of the novolac resin.

In a specific aspect of the positive-type photoresist according to the present invention, the positive-type photoresist comprises the novolac resin and the photosensitive novolac resin, wherein the photosensitive novolac resin is obtained by reacting 10 to 60 parts by weight of a photosensitive compound with 100 parts by weight of the novolac resin, and wherein the amount corresponding to the photosensitive compound is in the range of 5 to 50 parts by weight with respect to 100 parts by weight of total amount of the novolac resin and the photosensitive novolac resin.

In a more specific aspect of the positive-type photoresist according to the present invention, the photosensitive compound is 1,2-naphthoquinonediazidosulfonyl halide.

In the positive-type photoresist according to the present invention, it is preferred that 1 to 20 parts by weight of an anionic surfactant is mixed with 100 parts by weight of total amount of the novolac resin and a derivative of the novolac resin.

In the positive-type photoresist according to the present invention, it is preferred that 50 to 300 parts by weight of colloidal silica is mixed with 100 parts by weight of total amount of the novolac resin and a derivative of the novolac resin.

In the positive-type photoresist according to the first invention, 100 to 700 parts by weight of a viscosity-controlling agent is mixed with 100 parts by weight of total amount of the novolac resin and a derivative of the novolac resin.

The present invention is also directed to a method for manufacturing a structure having a circuit formed using a resist pattern, comprising the steps of:

forming a resist film on a surface of a substrate by the use of the positive-type photoresist according to the present invention;

exposing the resist film to light and carrying out development to obtain a resist pattern;

forming a circuit by the use of the resist pattern; and

removing the resist film.

In a specific aspect of the method according to the present invention, development is carried out using as a developer, an aqueous alkali solution whose alkali substance content is 0.3 wt % or less, in the step of exposing the resist film to light and carrying out development.

In the method for manufacturing a structure according to the present invention, it is preferred that the resist film is removed with ozone water in the step of removing the resist film.

The positive-type photoresist according to the present invention comprises a novolac resin having a weight-average molecular weight of 1,000 to 20,000 and a benzene nucleus to which two or more hydroxyl groups are bonded. Such a novolac resin is readily oxidized with ozone water because it has a benzene nucleus to which two or more hydroxyl groups are bonded. Therefore, Such a positive-type photoresist can be readily stripped by treatment with ozone water.

In order to promote degradation of a novolac resin with ozone water, it is necessary to allow the novolac resin to have a phenol ring structure which is readily oxidized with ozone. In general, the process of oxidation of a phenol ring is considered as follows. In the first step, a hydroxyl group is added to a phenol ring so that the phenol ring has two hydroxyl groups. In the second step, the phenol ring is further oxidized with ozone to produce two carboxyl groups so that the phenol ring opens. In view of such an oxidation process of a phenol ring, it can be considered that the use of a novolac resin having a benzene ring originally containing two or more hydroxyl groups makes it possible to omit the first step described above, thereby promoting oxidation with ozone smoothly.

As described above, the ozone-degradable novolac resin according to the present invention can be readily stripped by treatment with ozone water, thereby simplifying the step of stripping and reducing environmental loads.

Further, a larger number of hydroxyl groups bonded to a benzene ring in a novolac resin means that the novolac resin is more hydrophilic. For example, phenol is not readily dissolved in neutral water, but catechol having one more hydroxyl group than phenol is highly hydrophilic and is therefore readily dissolved in water. Therefore, a novolac resin having a structure in which two or more hydroxyl groups are bonded to a benzene ring readily swells in water. That is, the positive-type photoresist according to the present invention can be developed with weak alkaline water because the novolac resin readily swells in water. According to the present invention, it is possible to provide a positive-type photoresist which can be stripped with ozone water and developed with weak alkaline water. By using such a positive-type photoresist, it is possible to reduce the cost of a developer and simplify wastewater treatment.

Furthermore, the relatively highly hydrophilic positive-type photoresist according to the present invention hardly produces scum that is a residue of the resist remaining after development.

In positive-type photoresist according to the present invention, when a benzene nucleus has a structure represented by any one of the above formulas (1) to (6) to which two or more hydroxyl groups are bonded, it is possible to easily provide a positive-type photoresist of the invention which can be degraded with ozone water and developed with weak alkaline water.

Further, in the present invention, when the novolac resin is one obtained by alternating copolymerizarion of at least two kinds of monomers, the hydrophilicity or hydrophobicity of the novolac resin can be easily controlled, and therefore it is possible to easily provide a positive-type photoresist having an appropriate swelling property in water.

Furthermore, when the novolac resin is one obtained by alternating copolymerization of at least one kind of monomers represented by the above formulas (7) to (16) and at least one kind of monomers represented by the above formulas (17) to (26), wherein at least one kind of monomers represented by the above formulas (7), (8), (17), and (18) each containing two or more hydroxyl groups is used as a monomer for alternating copolymerization, it is possible to more easily provide a positive-type photoresist having an appropriate swelling property in water.

By using the dimethylols represented by the above formulas (17) to (26), even when phenols having different reactivity are used to prepare a novolac rein, it is possible to allow the novolac resin to contain their respective monomers evenly. In addition, it is also possible to place benzene nuclei, each containing two or more hydroxyl groups, at even intervals in the molecular chain. Therefore, a positive-type photoresist comprising such a novolac resin can be stripped with ozone water evenly and stably at high speed.

The positive-type photoresist obtained by using 30 parts by weight or more of total amount of the monomers represented by the above formulas (7), (8), (17), and (18) each containing two or more hydroxyl groups with respect to 100 parts by weight of total amount of the monomers represented by the above formulas (7) to (16) and the monomers represented by the above formulas (17) to (26) is more readily oxidized with ozone water because many skeletal portions having a benzene ring structure to which two or more hydroxyl groups are bonded exist. Therefore, the positive-type photoresist comprising can be more readily stripped by treatment with ozone water.

A derivative of the novolac resin obtained by replacing some of the hydroxyl groups of the novolac resin with a substituent by capping treatment is readily oxidized with ozone water. Therefore, the positive-type photoresist can be readily stripped by treatment with ozone water.

A derivative of the novolac resin obtained by esterifying and/or etherifying some of the hydroxyl groups of the novolac resin is oleophilic, and the positive-type photoresist comprising such a derivative of the novolac resin has an appropriate swelling property in water.

In a case where capping by etherification is carried out, when some of the hydroxyl groups are replaced using at least one compound selected from the group consisting of alkyl ether, aryl ether, benzyl ether, triarylmethyl ether, trialkylsilyl ether, and tetrahydropyranyl ether, the positive-type photoresist is excellent in heat resistance.

In a case where capping by esterification is carried out, when some hydroxyl groups are replaced using at least one compound selected from the group consisting of acetate, benzoate, methanesulfonic acid esters, and benzenesulfonic acid esters,the positive-type photoresist is not readily dissolved in alkali so that it is very stable during development with alkali.

As described above, the novolac resin having a structure in which two or more hydroxyl groups are bonded to a benzene ring or a derivative of the novolac resin obtained by replacing some of the hydroxyl groups of the novolac resin with the substituent mentioned above is likely to swell in water. From this, it can be considered that there is a possibility that the resolution of a photoresist comprising such a novolac resin or a derivative of the novolac resin is deteriorated. However, by mixing, for example, a photosensitive compound usually used such as naphthoquinonediazide with the novolac resin or a derivative of the novolac resin, it is possible to control the swelling property of the novolac resin in water, thereby inhibiting the degradation of resolution of the photoresist. That is, it is possible to develop the photoresist with weak alkaline water while inhibiting the degradation of resolution.

In the present invention, when 5 to 50 parts by weight of a photosensitive compound is mixed with 100 parts by weight of total amount of the novolac resin and a derivative of the novolac resin, it is possible to impart more adequate photosensitivity.

When a derivative of the novolac resin is a photosensitive novolac resin obtained by reacting the novolac resin with a photosensitive compound, such a photosensitive novolac resin has adequate photosensitivity and improved cross-linking efficiency. Therefore, a positive-type photoresist comprising such a photosensitive novolac resin can be readily oxidized with ozone water, that is, readily stripped by treatment with ozone water.

In this case, when the photosensitive novolac resin is obtained by reacting 5 to 50 parts by weight of a photosensitive compound with 100 parts by weight of the novolac resin, such a photosensitive novolac resin has adequate photosensitivity and more improved cross-linking efficiency.

When the positive-type photoresist comprises the novolac resin and the photosensitive novolac resin, wherein the photosensitive novolac resin is obtained by reacting 10 to 60 parts by weight of a photosensitive compound with 100 parts by weight of the novolac resin, and wherein the amount corresponding to the photosensitive compound is 5 to 50 parts by weight with respect to 100 parts by weight of total amount of the novolac resin and the photosensitive novolac resin, such a photosensitive novolac resin also has adequate photosensitivity and improved cross-linking efficiency.

When the photosensitive compound is 1,2-naphthoquinonediazidosulfonyl halide, it is possible to impart adequate photosensitivity and improve the cross-linking efficiency.

When the positive-type photoresist contains an anionic surfactant in an amount of 1 to 20 parts by weight with respect to 100 parts by weight of total amount of the novolac resin and a derivative of the novolac resin, such a positive-type photoresist can be readily stripped with ozone water.

In the present invention, when the positive-type photoresist contains colloidal silica in an amount of 50 to 300 parts by weight with respect to 100 parts by weight of total amount of the novolac resin and a derivative of the novolac resin, such a positive-type photoresist has an enhanced resistance to dry-etching and thermal deformation. Further, such a positive-type photoresist is readily stripped with ozone water, and therefore a circuit can be formed with a high degree of precision using a resist pattern.

When the positive-type photoresist contains a viscosity-controlling agent in an amount of 100 to 700 parts by weight with respect to 100 parts by weight of total amount of the novolac resin and a derivative of the novolac resin, it is possible to form a more uniform resist resin composition film.

The method for manufacturing a structure having a circuit formed using a resist pattern according to the present invention comprises the steps of forming a resist film using the positive-type photoresist according to the present invention, developing the resist film to obtain a resist pattern, forming a circuit using the resist pattern, and removing the resist film. In this method, the resist film can be developed with weak alkaline water which is not expensive, and can be readily stripped with ozone water. Therefore, it is possible to effectively reduce costs and environmental loads when manufacturing a structure having a circuit formed using the resist pattern.

In particular, by using an aqueous alkali solution whose alkali substance content is 0.3 wt % or less as a developer, it is possible to further reduce costs.

### BEST MODE FOR CARRYING OUT THE INVENTION

Hereinbelow, the present invention will be described in detail with reference to embodiments and Examples according to the present invention.

A positive-type photoresist according to the present invention comprises a specific novolac resin and/or a derivative of the novolac resin.

The novolac resin has a weight-average molecular weight of 1,000 to 20,000, and contains a benzene nucleus to which two or more hydroxyl groups are bonded.

Such a novolac resin can be obtained by mixing a phenol containing two or more hydroxyl groups, an aldehyde, and an acid catalyst to carry out addition polycondensation by heating.

Examples of such a phenol containing two or more hydroxyl groups include pyrocatechol, resorcinol, hydroquinone, pyrogallol, and fluoroglucinol.

In order to obtain a novolac resin according to the present invention, another phenol may be used together with the phenol containing two or more hydroxyl groups. Examples of such another phenol to be used together include m-cresol, p-cresol, xylenol, phenol, and trimethylphenol. As such xylenol mentioned above, for example, 2,3-xylenol, 2,4-xylenol, 2,5-xylenol, 2,6-xylenol, 3,4-xylenol, or 3,5-xylenol can be used. These phenols to be used together may be used singly or in combination of two or more of them.

Examples of an aldehyde compound to be used for obtaining such a novolac resin-described above include formaldehyde, benzaldehyde, vanillin, propyl aldehyde, and salicyl aldehyde.

In order to obtain a novolac resin according to the present invention, a phenol containing a hydroxymethyl group may be used as a raw material instead of the aldehyde compound mentioned above. Examples of such a phenol containing a hydroxymethyl group include 2,6-hydroxymethyl-4-methyl phenol and 4,6-dihydroxymethyl-2-methyl phenol. Even in a case where phenols having different reactivity are used, it is possible to allow the novolac resin to contain their respective monomers evenly. Further, it is also possible to synthesize a resin in which benzene nuclei, each containing two or more hydroxyl groups, are placed at even intervals in the molecular chain. A positive-type photoresist comprising such a resin can be evenly and stably stripped with ozone water at high speed.

A novolac resin according to the present invention can be obtained by mixing the raw materials described above together with an acid catalyst to carry out addition condensation polymerization by heating. Examples of the acid catalyst include oxalic acid, hydrochloric acid, and p-toluenesulfonic acid.

As described above, a phenol to be used as a raw material of a novolac resin according to the present invention contains a benzene ring to which two or more hydroxyl groups are bonded, and therefore a resultant novolac resin has a structure in which two or more hydroxyl groups derived from the phenol are bonded to a benzene ring.

The weight-average molecular weight of the novolac resin should be in the range of not less than 1,000 and not more than 20,000. If the weight-average molecular weight of the novolac resin is less than 1,000, there is a case where the sensitivity of the positive-type photoresist becomes too high to form an image. On the other hand, if the weight-average molecular weight of the novolac resin exceeds 20,000, the shape of a pattern is deteriorated.

The novolac resin obtained in such a manner described above preferably has a structure represented by any one of the formulas (1) to (6). That is, the benzene nucleus containing two or more hydroxyl groups has a structure represented by any one of the formulas (1) to (6).

As described above, the weight-average molecular weight of the novolac resin having functional groups capable of being changed to hydrophilic groups by bringing them into contact with ozone water should be in the range of 1,000 to 20,000, preferably in the range of 3,000 to 15,000, more preferably in the range of 5,000 to 10,000. If the weight-average molecular weight of the novolac resin is less than 1,000, there is a case where the sensitivity of the photoresist resin composition becomes too high to form an image. On the other hand, if the weight-average molecular weight of the novolac resin exceeds 20,000, there is a fear that the shape of a pattern is deteriorated.

A photoresist resin composition according to the present invention contains an ozone-degradable novolac resin prepared according to the present invention. The ozone-degradable novolac resin contains a benzene nucleus to which two or more hydroxyl groups are bonded, and therefore the photoresist resin composition containing such an ozone-degradable novolac resin can be readily stripped by bringing it into contact with ozone water.

The novolac resin constituting the positive-type photoresist according to the present invention is more preferably obtained by alternating copolymerization of at least two kinds of monomers. For example, two kinds of monomers are mixed, and an acid catalyst (e.g., oxalic acid, p-toluenesulfonic acid) and, when necessary, a solvent are added to the mixture to stir them with heating. Next, a solvent is added thereto to obtain a solution, and then the solution is fed into water vigorously stirred to remove excess monomers. Thereafter, an obtained precipitate is heated, and then vacuum drying is carried out to obtain a novolac resin.

Preferred examples of the monomer to be used for alternating copolymerization include monomers represented by the formulas (7) to (26). In this regard, it is to be noted that among these monomers represented by the formulas (7) to (26), at least one kind of monomers represented by the formulas (7), (8), (17), and (18) each containing two or more hydroxyl groups is used for alternating copolymerization.

Further, alternating copolymerization of at least one kind of monomers represented by the formulas (7) to (16) and at least one kind of monomers represented by the formulas (17) to (26) makes it possible to control the hydrophilic property or hydrophobic property of a novolac resin, thereby enabling a novolac resin having an appropriate swelling property in water to be obtained.

In alternating copolymerization, it is preferred that 30 parts by weight or more of total amount of monomers represented by the formulas (7), (8), (17), and (18) each containing two or more hydroxyl groups is mixed with 100 parts by weight of total amount of monomers represented by the formulas (7) to (16) and monomers represented by the formulas (17) to (26). If the total amount of monomers each containing two or more hydroxyl groups is less than 30 parts by weight, there is a case where the effect of oxidation with ozone water cannot be sufficiently obtained for lack of a skeletal portion having a benzene ring structure to which two or more hydroxyl groups are bonded in the novolac resin. It is to be noted that in a case where a large amount of a monomer containing two or more hydroxyl groups is used, a monomer having a high hydrophobic property should be used together with the monomer to carry out alternating copolymerization.

In the positive-type photoresist according to the present invention, some of the hydroxyl groups of the ozone-degradable novolac resin are preferably replaced with a substituent by capping treatment. A derivative of the novolac resin obtained by replacing with a substituent is oleophilic. The word “some of the hydroxyl groups” means some of the hydroxyl groups bonded to the benzene rings. In this case, capping is carried out by etherifying or esterifying some of the hydroxyl groups. In a case of etherification, capping is carried out using, for example, alkyl ether, aryl ether, benzyl ether, triaryl methyl ether, trialkylsilyl ether, or tetrahydropyranyl ether. Among these ethers, alkyl ether is preferably used. By using alkyl ether, it is possible to make the size of structure of a substituted portion smallest, which is desirable from the viewpoint of the heat resistance of a resist. In a case of esterification, capping is carried out using, for example, acetate, benzoate, methanesulfonic acid ester, or benzenesulfonic acid ester. In a case where capping is carried out by esterification, a resultant photoresist is more easily degraded with alkali as compared to a photoresist obtained by carrying out capping by etherification. Therefore, from the viewpoint of stability during development with alkali, capping is preferably carried out by etherification.

The weight-average molecular weight of such a derivative of the novolac resin obtained by replacing some of the hydroxyl groups of the ozone-degradable novolac resin having a weight-average molecular weight of 1,000 to 20,000 with a substituent is in substantially the same range, that is, in the range of 1,000 to 20,000.

The positive-type photoresist according to the present invention may contain a photosensitive compound suitable for forming a photoresist. Preferred examples of such a photosensitive compound include naphthoquinoneazide, naphthoquinonediazide, and esters thereof.

Specific examples thereof include naphthoquinonediazidosulfonyl halides such as 1,2-naphthoquinone-2-diazido-4-sulfonyl chloride and 1,2-naphthoquinone-2-diazido-5-sulfonyl chloride, available naphthoquinoneazides and naphthoquinonediazides, and esters thereof with phenol, p-methoxyphenol, hydroquinone, α-naphthol, 2,6-dihydroxynaphthalene, bisphenol A, or polyhydroxybenzophenone e.g., 2,3,4-trihydroxybezophenone, 2,4,4′-trihydroxybenzophenone, 2,4,6-trihydroxybenzophenone, 2,3,4,4′-trihydroxybenzophenone, or 2,2′,4,4′-trihydroxybenzophenone, such as 1,2-naphthoquinonediazide-5-sulfonic acid phenyl ester.

By mixing such a photosensitive compound such as 1,2-naphthoquinonediazidosulfonyl halide e.g., 1,2-naphthoquinone-2-diazido-4-sulfonyl chloride or 1,2-naphthoquinone-2-diazido-5-sulfonyl chloride with the novolac resin and/or a derivative of the novolac resin, it is possible to more effectively enhance photosensitivity.

The amount of the photosensitive compound to be mixed with the novolac resin and a derivative of the novolac resin is preferably 5 parts by weight or more but 50 parts by weight or less, more preferably 12.5 parts by weight or more but 25 parts by weight or less, with respect to 100 parts by weight of total amount of the novolac resin and a derivative of the novolac resin. If the amount exceeds 50 parts by weight, there is a fear that the sensitivity is lowered. If the amount is less than 5 parts by weight, there is a fear that the positive-type photoresist cannot have sufficient photosensitivity so that the film remaining ratio thereof is lowered.

The positive-type photoresist according to the present invention preferably comprises a photosensitive novolac resin obtained by reacting the novolac resin with a photosensitive compound.

As described above, a photosensitive novolac resin is obtained by mixing such an appropriate photosensitive compound mentioned above with the novolac resin to carry out reaction therebetween.

In order to improve cross-linking efficiency, the novolac resin may be esterified with the photosensitive compound such as 1,2-naphthoquinonediazidosulfonyl halide e.g., 1,2-naphthoquinone-2-diazido-4-sulfonyl chloride or 1,2-naphthoquinone-2-diazido-5-sulfonyl chloride. The amount of the novolac resin esterified with the photosensitive compound is preferably 5 parts by weight or more but 50 parts by weight or less, more preferably 12.5 parts by weight or more but 25 parts by weight or less, with respect to 100 parts by weight of the novolac resin. If the amount exceeds 50 parts by weight, there is a fear that the sensitivity is lowered. If the amount of the novolac resin esterified with the photosensitive compound is less than 5 parts by weight, there is a fear that cross-linking cannot be properly carried out so that the film remaining ratio is lowered.

As described above, the positive-type photoresist according to the present invention may comprise a photosensitive novolac resin obtained by esterifying the novolac resin with the photosensitive compound in such a specific ratio described above. In this case, the positive-type photoresist may comprise either only the photosensitive novolac resin or both the photosensitive novolac resin and the novolac resin other than the photosensitive novolac resin.

In a case where the positive-type photoresist comprises only the photosensitive novolac resin, 5 to 50 parts by weight of the photosensitive compound may be reacted with 100 parts by weight of the photosensitive novolac resin. If the amount of the photosensitive compound exceeds 50 parts by weight, there is a fear that the sensitivity is lowered. More preferably the amount is not more than 25 parts by weight. If the amount is less than 5 parts by weight, there is a fear that cross-linking cannot be properly carried out so that the film remaining ratio is lowered.

In a case where the positive-type photoresist according to the present invention comprises both the novolac resin and the photosensitive novolac resin, the amount corresponding to the photosensitive compound may be 5 to 50 parts by weight, more preferably 5 to 25 parts by weight, with respect to 100 parts by weight of total amount of the novolac resin and the photosensitive novolac resin. If the amount corresponding to the photosensitive compound exceeds 50 parts by weight, there is a fear that the sensitivity of the positive-type photoresist is lowered. If the amount corresponding to the photosensitive compound is less than 5 parts by weight, there is a fear that cross-linking cannot be properly carried out so that the film remaining ratio is lowered. In this case, the amount of the photosensitive compound to be reacted with the novolac resin to obtain a photosensitive novolac resin is not particularly limited, but is preferably 10 to 60 parts by weight with respect to 100 parts by weight of the novolac resin. If the amount of the photosensitive compound is less than 10 parts by weight, the amount of the photosensitive novolac resin to be mixed with the novolac resin that is not photosensitive is increased so that there is a case where the use efficiency of a resultant positive-type photoresist is lowered. On the other hand, if the amount of the photosensitive compound exceeds 60 parts by weight, the difference in cross-linking property tends to occur between the photosensitive novolac resin and the novolac resin which is not photosensitive so that there is a fear that the resolution of a resultant positive-type photoresist is lowered.

A preferred weight-average molecular weight of the photosensitive novolac resin obtained by reacting the novolac resin having a weight-average molecular weight of 1,000 to 20,000 with the photosensitive compound is in substantially the same range, that is, in the range of 1,000 to 20,000.

The positive-type photoresist according to the present invention preferably contains a surfactant. By adding a surfactant, it is possible to readily strip the photoresist with ozone water due to the micelle effect of the surfactant. As such a surfactant, an anionic surfactant is preferably used because it has a good micelle effect.

Preferred examples of the anionic surfactant include alkylbenzenesulfonic acid and alkylbenzenesulfonic acid sodium salt. The amount of the anionic surfactant to be added is preferably 1 to 20 parts by weight with respect to 100 parts by weight of total amount of the novolac resin and a derivative of the novolac resin. If the amount is less than 1 part by weight, there is a case where the effect of improving the strippability cannot be sufficiently obtained. On the other hand, if the amount exceeds 20 parts by weight, there is a fear that adhesion between the photoresist and a substrate becomes poor.

A nonionic surfactant is slightly inferior in micelle effect to the anionic surfactant, but a nonionic surfactant may be used instead of the anionic surfactant or together with the anionic surfactant.

The positive-type photoresist according to the present invention preferably contains colloidal silica. By adding colloidal silica, it is possible to allow the photoresist to have improved resistance to dry etching as well as improved resistance to thermal deformation. The amount of colloidal silica to be added is preferably 50 to 300 parts by weight with respect to 100 parts by weight of total amount of the novolac resin and a derivative of the novolac resin. If the amount is less than 50 parts by weight, the effect of improving resistance to dry etching and resistance to thermal deformation is not sufficiently exhibited. On the other hand, if the amount exceeds 300 parts by weight, there is a fear that agglomeration of colloidal silica occurs to form undesired particles in the photoresist.

The particle diameter of the colloidal silica is preferably 30 nm or less. Further, the colloidal silica is preferably added in the form of a 10 to 40 wt % colloidal silica dispersion. In this case, a polar solvent is preferably used as a dispersion medium. Examples of the polar solvent include methanol, isopropanol, ethylene glycol, ethylene glycol mono-n-propyl ether, dimethylacetamide, methyl ethyl ketone, and methyl isobutyl ketone.

If the particle diameter of the colloidal silica exceeds 30 nm, irregularities are likely to occur on the surface of a photoresist film. If the concentration of the colloidal silica dispersion is less than 10 wt %, the amount of a dispersion medium to be added becomes too much. If the concentration of the colloidal silica dispersion exceeds 40 wt %, agglomeration of colloidal silica is likely to occur, thus resulting in undesired particles.

The dispersion medium more preferably has excellent miscibility with the novolac resin. Preferred examples of such a dispersion medium include polar solvents such as isopropanol and methyl ethyl ketone.

The positive-type photoresist according to the present invention is usually prepared by dissolving the resist composition in an organic solvent. The organic solvent functions as a viscosity controlling agent when the positive-type photoresist is applied to a substrate. In this case, the amount of the viscosity controlling agent is 100 to 700 parts by weight with respect to 100 parts by weight of total amount of the novolac resin and a derivative of the novolac resin. Specific examples of the organic solvent include aromatic hydrocarbons such as toluene and xylene, acetates such as methylcellosolve acetate, ethylcellosolve acetate, ethylene glycol diacetate, and propylene glycol monomethyl ether acetate, cellosolves such as ethylcellosolve and methylcellosolve, and polar solvents such as γ-butyrolactone, ethyl lactate, butyl acetate, dimethyl oxalate, diacetone alcohol, diacetin, triethyl citrate, ethylene carbonate, and propylene carbonate. These organic solvents may be used singly or in combination of two or more of them. If the amount of the viscosity controlling agent is less than 100 parts by weight, it is difficult toprepare a uniform solution so that the photoresist tends to be unevenly applied. On the other hand, if the amount exceeds 700 parts by weight, the viscosity of the photoresist becomes too low so that there is a case where the thickness of the photoresist applied to a substrate becomes too thin.

In addition to the components described above, the positive-type photoresist according to the present invention contains an appropriate solvent capable of solving the essential components, for the purpose of ensuring storage stability. Examples of such a solvent include solvents which can be used as the viscosity controlling agent described above, such as methylcellosolve acetate, ethylcellosolve acetate, ethyl lactate, γ-butyrolactone, propylene glycol monomethyl ether acetate, ethylcellosolve, and methylcellosolve.

The positive-type photoresist according to the present invention is applied to, for example, a silicon substrate with a coater or the like by a well-known method. The positive-type photoresist applied to a substrate is dried, and is then exposed to light using, for example, a stepper to carry out development, thereby enabling a good resist pattern to be obtained. As a developer, various aqueous alkali solutions can be used. Examples of an alkali substance include sodium hydroxide, potassium hydroxide, ammonia, ethyl amine, triethyl amine, triethanol amine, and tetramethylammonium hydroxide.

It is to be noted that the developer may contain an alcohol or a surfactant.

In the method for manufacturing a structure according to the present invention, a very dilute alkaline developer can be used. In a case where a conventional positive-type photoresist is developed with an aqueous alkali solution, an aqueous tetramethylammonium hydroxide solution with a concentration of 2.38 wt % or more is usually used as described above. In this case, costs and environmental loads must become high. On the other hand, in a case where the positive-type photoresist according to the present invention is used, an aqueous alkali solution of low concentration can be used. For example, an aqueous tetramethylammonium hydroxide solution with a concentration of 0.3 wt % or less, preferably 0.1 wt % or less can be used. As a result, costs and environmental loads are reduced. More preferably, pure water may also be used as a developer instead of such an aqueous alkali solution. In this case, costs and environmental loads are further reduced.

The method for manufacturing a structure having a circuit formed using a resist pattern according to the present invention comprises the steps of forming a resist film by the use of the positive-type photoresist, exposing the resist film to light and carrying out development to obtain a resist pattern, forming a circuit by the use of the resist pattern, and removing the resist film. Each of the steps is carried out according to well-known photolithography. In this method, as described above, an aqueous alkali solution of low concentration or neutral water can be used as a developer, thereby reducing costs and environmental loads. Further, the resist film can be stripped with ozone water, thereby reducing costs of the step of removing the resist film and simplifying the step.

Examples of a structure manufactured by the method according to the present invention include substrates of semiconductor devices or LCDs. However, examples of such a structure are not limited to substrates, and also include members, on which a circuit pattern is to be formed using a photoresist, for use in various electronic parts.

Next, the present invention will be described in more detail with reference to Examples according to the present invention and Comparative Examples. The present invention is not limited to these Examples.

### EXAMPLE 1

Ten grams of catechol, 30 g of 2,6-dihydroxymethyl-4-methyl phenol, 0.25 g of oxalic acid as an acid catalyst, and 50 g of methyl isobutyl ketone as a solvent were placed in a 2-litter separable flask equipped with a stirrer, a thermometer, a heat exchanger, and an argon inlet, and they were heated with stirring for 2 hours at 100° C. Then, the thus obtained mixture was heated to 150° C., and water and the solvent were removed from the mixture at 150° C. under a reduced pressure. Then, the mixture was further subjected to reaction for 1 hour under a reduced pressure of 50 mmHg while being heated to 170° C., and was then cooled to obtain a resin sample of Example 1. The resin sample was analyzed by NMR and was found to have a structure represented by the following structural formula. The weight-average molecular weight of the resin sample was found to be 5,300 by GPC (Gel Permeation Chromatography).

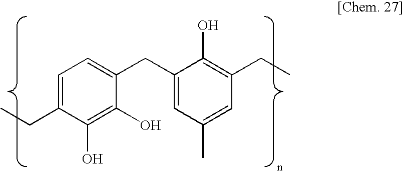

### EXAMPLE 2

Ten grams of catechol, 30 g of 2,6-dihydroxymethyl-4-methyl phenol, 0.25 g of oxalic acid as an acid catalyst, and 50 g of methyl isobutyl ketone as a solvent were placed in a 2-litter separable flask equipped with a stirrer, a thermometer, a heat exchanger, and an argon inlet, and they were heated with stirring for 2 hours at 100° C. Then, the thus obtained mixture was heated to 150° C., and water and the solvent were removed from the mixture at 150° C. Then, the mixture was heated to 170° C., further subjected to reaction for 1 hour under a reduced pressure of 50 mmHg, and was then cooled. The weight-average molecular weight of the product was found to be 5,300 by GPC. The cooled product was dissolved in a 13 wt % aqueous potassium hydroxide solution, and the thus obtained solution was maintained at 30° C. Ten grams of dimethyl sulfate was dropped into the solution in 30 minutes, and they were stirred for 4 hours to carryout reaction. After the completion of reaction, concentrated hydrochloric acid was dropped into the solution to adjust the pH to 2. Then, the solution was neutralized with a 10 wt % aqueous sodium bicarbonate solution. From the neutralized solution, an etherified novolac resin was extracted using 150 gof methyl isobutyl ketone. The etherified novolac resin extracted was washed with pure water 5 times, and was then concentrated with an evaporator to obtain a resin sample of Example 2. The resin sample was analyzed by NMR and was found to have a structure represented by the following structural formula. The weight-average molecular weight of the resin sample was found to be 6,200 by GPC.

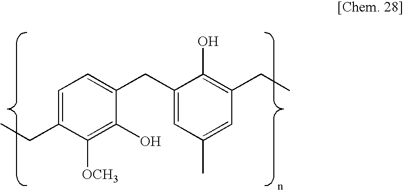

### EXAMPLE 3

Ten grams of catechol, 30 g of 2,6-dihydroxymethyl-4-methyl phenol, 0.25 gof oxalic acid, and 50 g of methyl isobutyl ketone were placed in a 2-litter separable flask equipped with a stirrer, a thermometer, a heat exchanger, and an argon inlet, and they were heated with stirring for 2 hours at 100° C. Then, the thus obtained mixture was heated to 150° C., and water and the solvent were removed from the mixture at 150° C.

Then, the mixture was heated to 170° C., further subjected to reaction for 1 hour under a reduced pressure of 50 mmHg, and was then cooled. The weight-average molecular weight of the product was found to be 5,300 by GPC. To the product, 50 g of acetone, 10 g of potassium carbonate, and 10 g of toluenesulfonyl chloride were added, and then they were stirred for 5 hours at 50° C. to carry out esterification. From the thus obtained solution, an esterified novolac resin was extracted using 150 g of methyl isobutyl ketone. The esterified novolac resin extracted was washed with pure water 5 times, and was then concentrated with an evaporator to obtain a resin sample of Example 3. The resin sample was analyzed by NMR and was found to have a structure represented by the following structural formula. The weight-average molecular weight of the resin sample was found to be 7,500 by GPC.

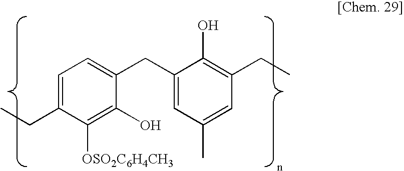

### COMPARATIVE EXAMPLE 1

20 g of o-cresol, 30 g of 2,6-dihydroxymethyl-4-methylphenol, 0.25 g of oxalic acid, and 50 g of methyl isobutyl ketone were placed in a flask, and they were heated with stirring for 2 hours at 100° C. Then, the thus obtained mixture was heated to 150° C., and water and the solvent were removed from the mixture at 150° C. Then, the mixture was heated to 170° C., further subjected to reaction for 1 hour under a reduced pressure of 50 mmHg, and was then cooled to obtain a resin sample. The resin sample was analyzed by NMR and was found to have a structure represented by the following structural formula. The weight-average molecular weight of the resin sample was found to be 8,800 by GPC.

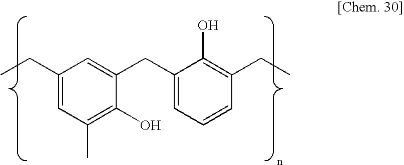

### EVALUATION OF EXAMPLES 1 TO 3 AND COMPARATIVE EXAMPLE 1

A photoresist resin composition was prepared using each of the resin samples of Examples 1 to 3 and Comparative Example 1 in the following manner. Then, the stripping rate with ozone water and the shape of a resist pattern were evaluated.

(1) Measurement of Stripping Rate with Ozone Water

One gram of the sample resin, 0.25 g of naphthoquinonediazidosulfonic acid (“NEC-4”, Toyo Gosei Co., Ltd.), 2 g of ethyl lactate, and 2 g of tetrahydrofuran were mixed to obtain a photoresist solution. Next, the photoresist solution was applied onto a silicon substrate, onto which hexamethyldisilazane had been evaporated, by a spin coating method, and was then dried by heating for 2 minutes at 90° C. to form a resist film having a thickness of 0.8 μm.

Ozone water of high concentration of 100 ppm was sprayed on the resist film through a perforated plate at a flow rate of 2.13 mL/min per hole. It is to be noted that the interval between holes of the perforated plate was 1 mm and the diameter of the hole of the perforated plate was 0.1 mm. The temperature of the ozone water at that time was 50° C. Thereafter, the thickness of the resist film was measured using a thin film measurement instrument for semiconductors (“SMAT”, Technos Co., Ltd.). It is to be noted that the unit of the stripping rate with ozone water was μm/min. The measurement results are shown in Table 1.

(2) Evaluation of Shape of Resist Pattern

A resist pattern with 0.5 μm lines and spaces was transferred to the resist film formed in the above (1) by exposure using a stepper (“NSR1755i7B”, Nikon Corporation, NA=0.54), and the film was immersed in a 2.38 wt % aqueous tetramethylammonium hydroxide solution to carry out development. Thereafter, baking was carried out for 2 minutes at 150° C., and then the cross-sectional shape of the resist pattern was observed by SEM. The results are shown in Table 1, wherein the mark “A” means that the cross-sectional shape of the resist pattern was a rectangle, the mark “B” means that the cross-sectional shape of the resist pattern was a trapezoid in which the upper corners were rounded, and the mark “C” means that the cross-sectional shape of the resist pattern was an isosceles triangle in which the upper side was rounded.

TABLE 1

| | Stripping Rate with Ozone | Shape of |
|---|---|---|
| | (μm/min) | Resist Pattern |
| Example 1 | 3.9 | C |
| Example 2 | 2.1 | A |
| Example 3 | 2.7 | A |
| Comaprative | 1.0 | A |
| Example 1 | | |

### EXAMPLE 4

Twenty five grams of resorcinol, 31 g of 2,6-dihydroxymethyl-4-methyl phenol, 0.25 g of oxalic acid as an acid catalyst, and 50 g of methyl isobutyl ketone as a solvent were placed in a 2-litter separable flask equipped with a stirrer, a thermometer, a heat exchanger, and an argon inlet, and they were heated with stirring for 2 hours at 100° C. Then, the mixture was heated to 120° C., further subjected to reaction for 1 hour under a reduced pressure of 50 mmHg to remove water and the solvent from the mixture, and was then cooled to obtain a novolac resin.

The novolac resin was analyzed according to the method described below and was found to have a structure represented by the following structural formula. The weight-average molecular weight of the novolac resin was 5,500.

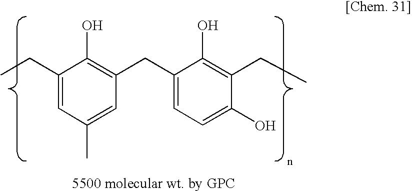

Twenty five parts by weight of naphthoquinonediazidosulfonic acid ester (“NAC-4”, Toyo Gosei Co., Ltd) as a photosensitive cross-linking agent and 400 parts by weight of ethyl lactate as a solvent were added to 100 parts by weight of the novolac resin to dissolve the cross-linking agent and the novolac resin in the solvent. The thus obtained solution was filtered using a 0.2 μm filter made of ethylene fluoride resin to prepare a resist solution.

The resist solution was applied onto a silicon wafer by a spin coating method, and was baked for 90 seconds at 120° C. on a hot plate to form a resist film having a thickness of 0.8 μm.

A resist pattern with 0.5 μm lines and spaces was transferred to the resist film by exposure using a stepper (“NSR1755i7B”, Nikon Corporation, NA=0.54), and then the resist film was baked for 60seconds at 120° C. on a hot plate. The resist film was immersed in a 0.1 wt % aqueous tetramethylammonium hydroxide solution for 1 minute to carry out development, and was then washed with water. Thereafter, the resist film was dried for 2 minutes at 120° C. on a hot plate.

### EXAMPLE 5

A novolac resin was prepared in the same manner as in Example 4 except that the amount of resorcinol used was changed to 50 g.

The thus obtained novolac resin was found to have a structure represented by the following structural formula. The weight-average molecular weight of the novolac resin was 3,800.

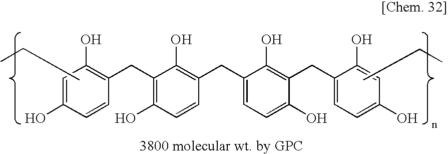

A resist solution was prepared, and a resist film was formed and exposure and development were carried out in the same manner as in Example 4.

### EXAMPLE 6

A resist solution was prepared in the same manner as in Example 4 except that 5 parts by weight of alkylbenzenesulfonic acid was further added to 100 parts by weight of the novolac resin, and exposure and development were carried out in the same manner as in Example 4.

Twenty parts by weight of 1,2-naphthoquinone-2-diazide-5-sulfonyl chloride and 800 parts by weight of tetrahydrofuran were mixed with 100 parts by weight of the novolac resin prepared in Example 4 to obtain a solution.

Into this solution, 12 parts by weight of triethyl amine and 800 parts by weight of tetrahydrofuran were dropped in 30 minutes while controlling the temperature of the entire solution at 30 to 40° C. The thus obtained mixture was stirred for 10 minutes, and was then fed into 20,000 parts by weight of 0.01 M hydrochloric acid to obtain a precipitate. The precipitate was thoroughly washed with water, and was then vacuum-dried at 60° C. to prepare a compound in which the novolac resin was esterified with naphthoquinonediazide.

The thus obtained compound was analyzed by the analysis method described below, and was found to have a structure represented by the following structural formula. The weight-average molecular weight of the compound was 6,300.

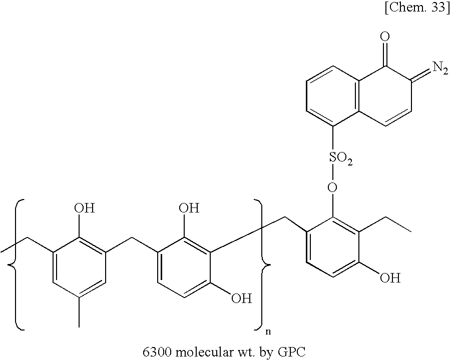

Five hundreds parts by weight of ethyl lactate was added to 100 parts by weight of the compound to dissolve the compound. The thus obtained solution was filtered using a 0.2 μm filter made of ethylene fluoride resin to prepare a resist solution.

A sample was prepared in the same manner as in Example 4.

### EXAMPLE 8

A sample was prepared in the same manner as in Example 7 except that the amount of 1,2-naphthoquinone-2-diazido-5-sulfonyl chloride used for esterification was changed to 12.5 parts by weight. The structure of the compound obtained by esterification was the same as that of the compound of Example 7, and the weight-average molecular weight of the compound was 5,700.

### COMPARATIVE EXAMPLE 2

Twenty grams of o-cresol, 30 g of 2,6-dihydroxymethyl-4-methyl phenol, 0.25 g of oxalic acid as an acid catalyst, and 50 g of methyl isobutyl ketone as a solvent were placed in a 2-litter separable flask equipped with a stirrer, a thermometer, a heat exchanger, and an argon inlet, and they were heated with stirring for 2 hours at 100° C. Then, the mixture was heated to 170° C., further subjected to reaction for 1 hour under a reduced pressure of 50 mmHg, and was then cooled to obtain a novolac resin. The novolac resin was analyzed according to the method described below, and was found to have a structure represented by the following structural formula. The weight-average molecular weight of the novolac resin was 7,500.

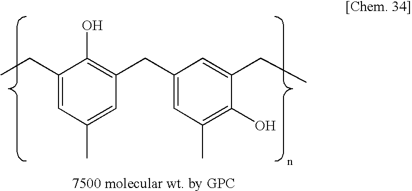

Twenty five parts by weight of naphthoquinonediazidosulfonic acid ester (“NAC-4”, Toyo Gosei Co., Ltd) as a photosensitive cross-linking agent and 400 parts by weight of ethyl lactate as a solvent were added to 100 parts by weight of the novolac resin to dissolve. The thus obtained solution was filtered using a 0.2 μm filter made of ethylene fluoride resin to prepare a resist solution.

The resist solution was applied onto a silicon wafer by a spin coating method, and was baked for 90 seconds at 120° C. on a hot plate to form a resist film having a thickness of 0.8 μm.

A resist pattern with 1.5 μm lines and spaces was transferred to the resist film by exposure using a stepper (“NSR1755i7B”, Nikon Corporation, NA=0.54), and then the resist film was baked for 60 seconds at 120° C. on a hot plate. It is to be noted that the resist is not dissolved in an aqueous alkali solution of low concentration (that is, in a 0.1 wt % aqueous tetramethylammonium hydroxide solution). Therefore, the resist film was immersed in a 2.38 wt % aqueous tetramethylammonium hydroxide solution usually used for 1 minute to carry out development, and was then washed with water. Thereafter, the resist film was dried for 5 minutes at 120° C. on a hot plate.

### COMPARATIVE EXAMPLE 3

A sample was prepared in the same manner as in Comparative Example 2 except that the amount of naphthoquinonediazidosulfonic acid ester (“NAC-4”, Toyo Gosei Co., Ltd.) used as a photosensitive cross-linking agent was changed to 12.5 parts by weight.

It is to be noted that the resist is not dissolved in an aqueous alkali solution of low concentration (that is, in a 0.1 wt % aqueous tetramethylammonium hydroxide solution). Therefore, development was carried out in the same manner as in Comparative Example 2.

### EVALUATION OF EXAMPLES 4 TO 8 AND COMPARATIVE EXAMPLES 2 AND 3

(1) Measurement of Stripping Rate with Ozone

Ozone water of high concentration of 100 ppm was sprayed on the resist film, on which a pattern had been formed, through a perforated plate (with 380 holes) at a flow rate of 2.13 mL/min per hole. It is to be noted that the diameter of the hole of the perforated plate was 0.1 mmφ. The temperature of the ozone water at that time was controlled at 50° C. Thereafter, the thickness of the resist film was measured using a thin film measurement instrument for semiconductors (“SMAT”, Technos Co., Ltd.). It is to be noted that the unit of the stripping rate with ozone was μm/min. The measurement results are shown in Table 2.

(2) Evaluation of Shape of Resist Pattern

The cross-sectional shape of the resist pattern was observed by SEM. The results are shown in Table 2, wherein the mark “A” means that the cross-sectional shape of the resist pattern was a rectangle, the mark “B” means that the cross-sectional shape of the resist pattern was a trapezoid in which the upper corners were rounded, and the mark “C” means that the cross-sectional shape of the resist pattern was an isosceles triangle in which the upper side was rounded.

(3) Evaluation of Heat Resistance

The samples were baked for 5minutes at 120° C., 130° C., 140° C., 150° C., 160° C., and17° C. on a hot plate, respectively. Thereafter, each of the samples was observed with a microscope to determine the temperature at which the resist pattern was deformed as a heat resistant temperature. The results are shown in Table 2.

(4) Evaluation of Development with Alkali of Low Concentration

The sample was immersed in 0.3 wt % tetramethylammonium hydroxide instead of 2.38 wt % tetramethylammonium hydroxide usually used for 1 minute to carry out development to check, and was determined that development with alkal solution of low concentration was possible when an image was embossed. The results are shown in Table 2.

(5) Analysis of Structure of Resin Sample or Compound

The molecular structure of the synthesized novolac resin or compound was estimated by ¹³C-NMR using an FT-NMR spectrometer (“JNM-AL300”, JEOL). The ratio of each carbon was calculated from the integral of each peak to estimate the structure of each of the novolac resins and compounds.

(6) Measurement of Molecular Weight

The molecular weights were measured by GPC (Gel Permeation Chromatography). GPC was carried out using a GPC column (“SHODEX FD-2002”, Showa Denko K.K.) and THF as an eluent at a flow rate of 1 mL/min. Molecular weight was calibrated using polystyrene standards.

(7) Determination of Presence or Absence of Scum

Each of the samples was observed with an optical microscope (100X) to check as to whether or not scum was produced. The results are shown in Table 2, wherein the mark “A” means that no scum was produced and the mark “C” means that scum was produced.

TABLE 2

| | | | Heat | | | Development |
|---|---|---|---|---|---|---|
| | | Stripping Rate | Resistance | Shape of | | with Alkali |
| Evaluation | | with Ozone | (Deformation | Resist | | Solution of Low |
| Results | | (μm/min) | Temp. ° C.) | Pattern | Scum | Concentration |
| Ex. | 4 | 2.3 | 150 | A | A | Developed |
| | 5 | 3.3 | 160 | B | A | Developed |
| | 6 | 2.9 | 150 | B | A | Developed |
| | 7 | 1.8 | 150 | A | A | Developed |
| | 8 | 2.2 | 150 | B | A | Developed |
| Comp. Ex. | 2 | 1.0 | 150 | A | C | Not Developed |
| | 3 | 1.4 | 140 | C | A | Not Developed |

### EXAMPLE 9

Twenty five grams of resorcinol, 31 g of 2,6-dihydroxymethyl-4-methylphenol, 0.25 g of oxalic acid as an acid catalyst, and 50 g of methyl isobutyl ketone as a solvent were placed in a 2-litter separable flask equipped with a stirrer, a thermometer, a heat exchanger, and an argon inlet, and they were heated with stirring for 2 hours at 100° C. Then, the mixture was heated to 120° C., further subjected to reaction for 1 hour under a reduced pressure of 50 mmHg to remove water and the solvent from the mixture, and was then cooled to obtain a novolac resin.

The novolac resin was analyzed by NMR in the same manner as in Examples 4 to 8 and found to have a structure represented by the following structural formula. The weight-average molecular weight of the novolac resin was found to be 5,500 by GPC.

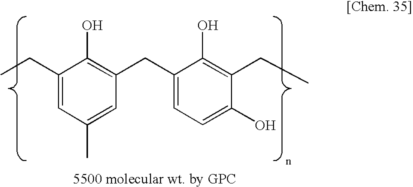

Twenty five parts by weight of naphthoquinonediazidosulfonic acid ester (“NAC-4”, Toyo Gosei Co., Ltd) as a photosensitive cross-linking agent, an isopropanol solution of colloidal silica (solid content: 30 wt %), and 400 parts by weight of ethyl lactate as a solvent were added to 100 parts by weight of the novolac resin to dissolve. The thus obtained solution was filtered using a 0.2 μm filter made of ethylene fluoride resin to prepare a resist solution.

The resist solution was applied onto a silicon wafer by a spin coating method, and was baked for 90 seconds at 120° C. on a hot plate to form a resist film having a thickness of 0.8 μm.

A resist pattern with 0.5 μm lines and spaces was transferred to the resist film by exposure using a stepper (“NSR1755i7B”, Nikon Corporation, NA=0.54), and then the resist film was baked for 60 seconds at 120° C. on a hot plate. The resist film was immersed in a 0.1 wt % aqueous tetramethylammonium hydroxide solution for 1 minute to carry out development, and was then washed with water. Thereafter, the resist film was dried for 2 minutes at 120° C. on a hot plate.

### EXAMPLE 10

A sample was prepared in the same manner as in Example 9 except that the amount of an isopropanol solution of colloidal silica (“IPA-ST”, Nissan Chemical Industries, Ltd., solid content: 30 wt %) was changed to 300 parts by weight (the amount of colloidal silica was 90 parts by weight with respect to 100 parts by weight of the novolac resin) and the amount of ethyl lactate was changed to 300 parts by weight.

### EXAMPLE 11

A sample was prepared in the same manner as in Example 9 except that the amount of an isopropanol solution of colloidal silica (“IPA-ST”, Nissan Chemical Industries, Ltd., solid content: 30 wt %) was changed to 900 parts by weight (the amount of colloidal silica was 270 parts by weight with respect to 100 parts by weight of the novolac resin) and the amount of ethyl lactate was changed to 100 parts by weight.

### COMPARATIVE EXAMPLE 4

Twenty grams of o-cresol, 30 g of 2,6-dihydroxymethyl-4-methyl phenol, 0.25 g of oxalic acid as an acid catalyst, and 50 g of methyl isobutyl ketone as a solvent were placed in a 2-litter separable flask equipped with a stirrer, a thermometer, a heat exchanger, and an argon inlet, and they were heated with stirring for 2 hours at 100° C. Then, the mixture was heated to 150° C., and then water and the solvent were removed from the mixture at 150° C.

Then, the mixture was heated to 170° C., further subjected to reaction for 1 hour under a reduced pressure of 50 mmHg, and was then cooled to obtain a novolac resin.

The novolac resin was analyzed by NMR in the same manner as in Examples 4 to 8 and was found to have a structure represented by the following structural formula. The weight-average molecular weight of the novolac resin was found to be 7,500 by GPC.

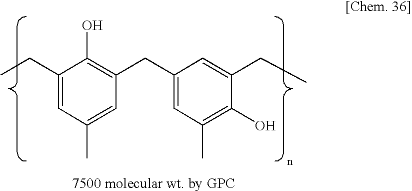

Twenty five parts by weight of naphthoquinonediazidosulfonic acid ester (“NAC-4”, Toyo Gosei Co., Ltd) as a photosensitive cross-linking agent and 400 parts by weight of ethyl lactate as a solvent were added to 100 parts by weight of the novolac resin to dissolve. The thus obtained solution was filtered using a 0.2 μm filter made of ethylene fluoride resin to prepare a resist solution (which contained no colloidal silica).

The resist solution was applied onto a silicon wafer by a spin coating method, and was baked for 90 seconds at 120° C. on a hot plate to form a resist film having a thickness of 0.8 μm.

A resist pattern with 1.5 μm lines and spaces was transferred to the resist film by exposure using a stepper (“NSR1755i7B”, Nikon Corporation, NA=0.54), and then the resist film was baked for 60 seconds at 120° C. on a hot plate. It is to be noted that the resist is not dissolved in an aqueous alkali solution of low concentration (that is, in a 0.1 wt % aqueous tetramethylammonium hydroxide solution). Therefore, the resist film was immersed in a 2.38 wt % aqueous tetramethylammonium hydroxide solution usually used for 1 minute to carry out development, and was then washed with water. Thereafter, the resist film was dried for 5 minutes at 120° C. on a hot plate.

### COMPARATIVE EXAMPLE 5

A sample was prepared in the same manner as in Comparative Example 4 except that 100 parts by weight of an isopropanol solution of colloidal silica (“IPA-ST”, Nissan Chemical Industries, Ltd., solid content: 30 wt %) was added (the amount of colloidal silica was 30 parts with respect to 100 parts of the novolac resin) and the amount of ethyl lactate was changed to 400 parts by weight.

### COMPARATIVE EXAMPLE 6

A sample was prepared in the same manner as in Comparative Example 4 except that 120 parts by weight of an isopropanol solution of colloidal silica (“IPA-ST”, Nissan Chemical Industries, Ltd., solid content: 30 wt %) was added (the amount of colloidal silica was 360 parts with respect to 100 parts of the novolac resin) and ethyl lactate was not added.

The resist film applied onto a silicon wafer clearly had a rough surface which appeared to be caused by particles.

### EVALUATION OF EXAMPLES 9 TO 11 AND COMPARATIVE EXAMPLES 4 TO 6

(1) Measurement of Stripping Rate with Ozone

Ozone water of high concentration of 100 ppm was sprayed on the resist film, on which a pattern had been formed, through a perforated plate (with 380 holes) at a flow rate of 2.13 mL/min per hole. It is to be noted that the diameter of the hole of the perforated plate was 0.1 mmφ. The temperature of the ozone water was controlled at 50° C. Thereafter, the thickness of the resist film was measured using a thin film measurement instrument for semiconductors (“SMAT”, Technos Co., Ltd.). It is to be noted that the unit of the stripping rate with ozone was μm/min. The measurement results are shown in Table 3.

(2) Evaluation of Shape of Resist Pattern

The cross-sectional shape of the resist pattern was observed by SEM. The results are shown in Table 3, wherein the mark “A” means that the cross-sectional shape of the resist pattern was a rectangle, the mark “B” means that the cross-sectional shape of the resist pattern was a trapezoid in which the upper corners were rounded, and the mark “C” means that the cross-sectional shape of the resist pattern was an isosceles triangle in which the upper side was rounded.

(3) Evaluation of Heat Resistance

The samples were baked for 5minutes at 120° C., 130° C., 140° C., 150° C., 160° C., and170° C. on a hot plate, respectively. Thereafter, each of the samples was observed with a microscope to determine the temperature at which the resist pattern was deformed as a heat resistant temperature. The results are shown in Table 3.

(4) Evaluation of Dry Etching Resistance

The sample was placed in a parallel plate-type dry etching apparatus (with an interval between electrodes of 40 mm), and was dry-etched with CF4/02 (volume ratio: 95/5) plasma at an output of 100 W and a gas pressure of 15 Pa to evaluate dry etching resistance. Dry etching resistance was evaluated based on a ratio between a resist etching rate and a silicon oxide film etching rate (that is, based on the value of silicon oxide film dry etching rate/resist dry etching rate). The results are shown in Table 3.

TABLE 3

| | | Colloidal | | Evaluation of | | Dry |
|---|---|---|---|---|---|---|
| | | Silica | Stripping | Heat | Shape | Etching |
| | | (Parts | Rate with | Resistance | of | Resist- |
| Evaluation | | by | Ozone | (Deformation | Resist | ance |
| Results | | Weight) | (μm/min) | Temp. ° C.) | Pattern | (Ratio) |
| Ex. | 9 | 150 | 1.4 | 150 | A | 4.9 |
| | 10 | 90 | 1.6 | 170 | A | 4.5 |
| | 11 | 270 | 1.1 | 190 | A | 5.1 |
| Comp. | 4 | 0 | 2.3 | 150 | A | 3.2 |
| Ex. | 5 | 30 | 2.2 | 150 | A | 3.2 |
| | 6 | 360 | 0.5 | 190 | B | 5.5 |

### EXAMPLE 12

Resorcinol (110.1 g), 168.1 g of 2,6-dimethylol-p-cresol, 0.5 g of oxalic acid, and 1,000 g of ethyl lactate were placed in a 2-litter separable flask equipped with a stirrer, a thermometer, a heat exchanger, and an argon inlet, and they were heated with stirring for 2 hours at 100° C. Then, the mixture was heated to 150° C. to remove water and the solvent from the mixture.

Then, the mixture was heated to 170° C., further subjected to reaction for 1 hour under a reduced pressure of 50 mmHg, and was then cooled to obtain a novolac resin. The weight-average molecular weight of the novolac resin was found to be 4,000 by GPC (Gel Permeation Chromatography).

### EXAMPLE 13

m-Cresol (108.1 g), 170.1 g of 2,6-dimethylol-resorcinol, 0.5 g of oxalic acid, and 1,000 g of ethyl lactate were placed in a 2-litter separable flask equipped with a stirrer, a thermometer, a heat exchanger, and an argon inlet, and they were heated with stirring for 2 hours at 100° C. Then, the mixture was heated to 150° C. to remove water and the solvent from the mixture.

Then, the mixture was heated to 170° C., further subjected to reaction for 1 hour under a reduced pressure of 50 mmHg, and was then cooled to obtain a novolac resin. The weight-average molecular weight of the novolac resin was found to be 3,500 by GPC (Gel Permeation Chromatography).

### EXAMPLE 14

Resorcinol (66.1 g), 43.3 g of m-cresol, 168.1 g of 2,6-dimethylol-p-cresol, 0.5 g of oxalic acid, and 1,000 g of ethyl lactate were placed in a 2-litter separable flask equipped with a stirrer, a thermometer, a heat exchanger, and an argon inlet, and they were heated with stirring for 2 hours at 100° C. Then, the mixture was heated to 150° C. to remove water and the solvent from the mixture.

Then, the mixture was heated to 170° C., further subjected to reaction for 1 hour under a reduced pressure of 50 mmHg, and was then cooled to obtain a novolac resin. The weight-average molecular weight of the novolac resin was found to be 3,300 by GPC (Gel Permeation Chromatography).

### EXAMPLE 15

m-Cresol (108.1 g), 108.1 g of p-cresol, 68.5 g of a 37% aqueous formaldehyde solution, 0.5 g of oxalic acid, and 1,000 g of ethyl lactate were placed in a 2-litter separable flask equipped with a stirrer, a thermometer, a heat exchanger, and an argon inlet, and they were heated with stirring for 2 hours at 100° C. Then, the mixture was heated to 150° C. to remove water and the solvent from the mixture.

Then, the mixture was heated to 170° C., further subjected to reaction for 1 hour under a reduced pressure of 50 mmHg, and was then cooled to obtain a novolac resin. The weight-average molecular weight of the novolac resin was found to be 2,100 by GPC (Gel Permeation Chromatography).

### COMPARATIVE EXAMPLE 7

m-Cresol (108.1 g), 108.1 g of p-cresol, 68.5 g of a 37% aqueous formaldehyde solution, 0.5 g of oxalic acid, and 1,000 g of ethyl lactate were placed in a 2-litter separable flask equipped with a stirrer, a thermometer, a heat exchanger, and an argon inlet, and they were heated with stirring for 2 hours at 100° C. Then, the mixture was heated to 150° C. to remove water and the solvent from the mixture.

Then, the mixture was heated to 170° C., further subjected to reaction for 1 hour under a reduced pressure of 50 mmHg, and was then cooled to obtain a novolac resin.

The weight-average molecular weight of the novolac resin was found to be 2,100 by GPC (Gel Permeation Chromatography).

### EVALUATION OF EXAMPLES 12 TO 15 AND COMPARATIVE EXAMPLE 7)

(1) Measurement of Stripping Rate with Ozone

Twenty five parts by weight of naphthoquinonediazidosulfonic acid ester as a photosensitive cross-linking agent and 400 parts by weight of ethyl lactate as a solvent were added to 100 parts by weight of each of the novolac resins prepared in Examples 12 to 15 and Comparative Example 7 to dissolve. Each of the thus obtained solutions was filtered using a 0.2 μm filter made of ethylene fluoride resin to prepare a resist solution.

The resist solution was applied onto a silicon substrate, on which hexamethyldisilazane had been evaporated, by a spin coating method, and was dried by heating for 2 minutes at 90° C. to form a resist film having a thickness of 0.8 μm.

Ozone water of high concentration of 100 ppm was sprayed on the resist film through a perforated plate at a flow rate of 2.13 mL/min per hole. It is to be noted that the interval between holes of the perforated plate was 1 mm and the diameter of the hole of the perforated plate was 0.1 mm. The temperature of the ozone water at that time was 50° C. Thereafter, the thickness of the resist film was measured using a thin film measurement instrument for semiconductors (“SMAT”, Technos Co. Ltd.). It is to be noted that the unit of the stripping rate with ozone was μm/min. The measurement results are shown in Table 4.

TABLE 4

| | Stripping Rate with Ozone |
|---|---|
| | (μm/min) |
| Example 12 | 2.1 |
| Example 13 | 2.0 |
| Example 14 | 1.5 |
| Example 15 | 1.9 |
| Comparative | 1.0 |
| Example 7 | |

(2) Measurement of Resorcinol Content by NMR

Each of the reins of Examples 12 and 13 was dissolved in heavy acetone, and was then subjected to ¹H-NMR to measure the ratio of a hydroxyl group present in the molecule and the ratio of a methyl group present in the molecule. From these ratios, the ratio of resorcinol present in the molecule was calculated. The results are shown in Table 5.

TABLE 5

| | Resorcinol Content (%) |
|---|---|
| Example 12 | 48 |
| Example 13 | 51 |
| Example 14 | 31 |
| Example 15 | 40 |
| Comparative | 69 |
| Example 7 | |

1. A positive-type photoresist comprising:
a novolac resin which has a benzene nucleus containing two or more hydroxyl groups and has a weight-average molecular weight of 1,000 to 20,000 and/or a derivative of the novolac resin,
said novolac resin being obtained by alternating copolymerization of at least one kind of monomers represented by the following formulas (7) to (16) and at least one kind of monomers represented by the following formulas (17) to (26) and wherein at least one kind of monomers represented by the following formulas (7), (8), (17) and (18) each containing two or more hydroxyl groups is used as the monomer for alternating copolymerization: 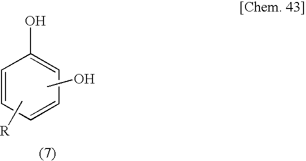 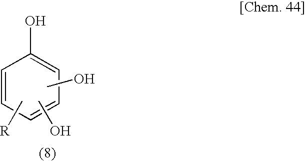 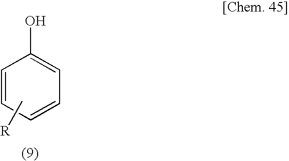 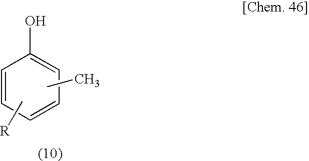 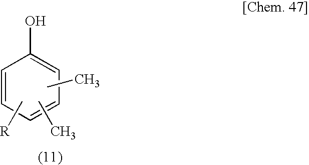 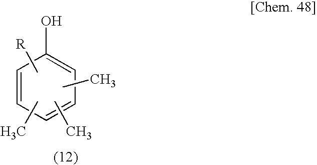 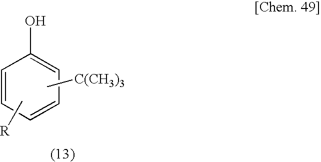 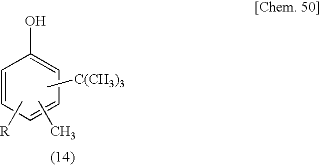 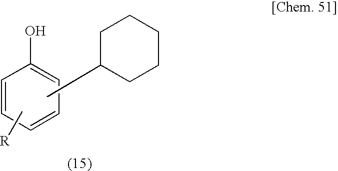 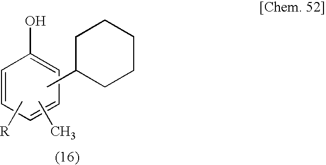 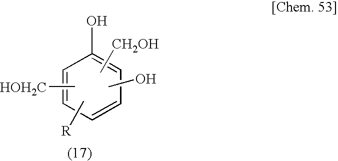 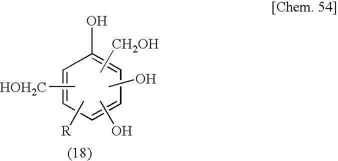 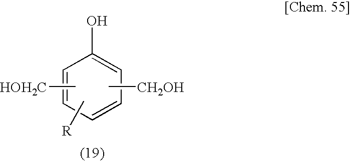 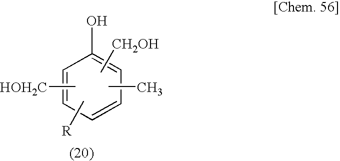 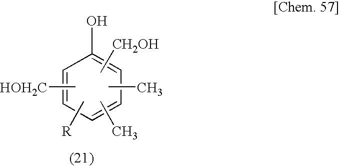 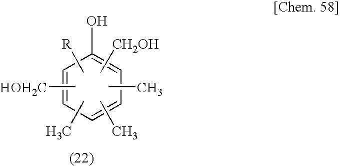 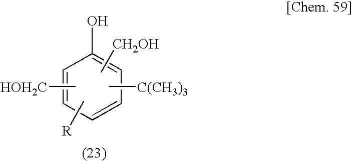 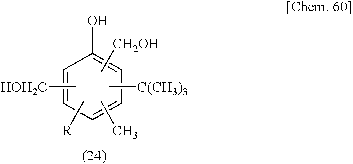 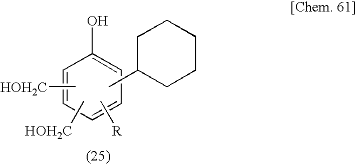 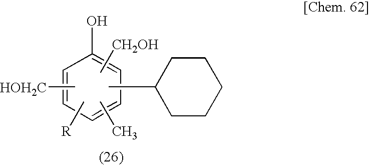
where R in each of the formulas (7) to (26) represents a hydrogen atom or a lower alkyl group having 6 or less carbon atoms.

2-4. (canceled)

5. The positive-type photoresist according to claim 1, wherein 30 parts by weight or more of the total amount of the monomers represented by the formulas (7), (8), (17), and (18) each containing two or more hydroxyl groups is used with respect to 100 parts by weight of total amount of the monomers represented by the formulas (7) to (16) and the monomers represented by the formulas (17) to (26).

6. The positive-type photoresist according to claim 1 or 5, wherein the derivative of the novolac resin is obtained by replacing some of the hydroxyl groups of the novolac resin with a substituent.

7. The positive-type photoresist according to claim 6, wherein some of the hydroxyl groups are esterified and/or etherified.

8. The positive-type photoresist according to claim 6, wherein the replacement of some of the hydroxyl groups with a substituent is carried out using at least one compound selected from the group consisting of alkyl ethers, aryl ethers, benzyl ethers, triarylmethyl ethers, trialkylsilyl ethers, and tetrahydropyranyl ethers.

9. The positive-type photoresist according to claim 6, wherein the replacement of some of the hydroxyl groups with a substituent is carried out using at least one compound selected from the group consisting of acetate, benzoate, methanesulfonic acid esters, and benzenesulfonic acid esters.

10. The positive-type photoresist according to claim 1, further comprising a photosensitive compound.

11. The positive-type photoresist according to claim 10, wherein 5 to 50 parts by weight of the photosensitive compound is mixed with 100 parts by weight of total amount of the novolac resin and a derivative of the novolac resin.

12. The positive-type photoresist according to claim 1, wherein the derivative of the novolac resin is a photosensitive novolac resin obtained by reacting the novolac resin with a photosensitive compound.

13. The positive-type photoresist according to claim 12, wherein the photosensitive novolac resin is one obtained by reacting 5 to 50 parts by weight of the photosensitive compound with 100 parts by weight of the novolac resin.

14. The positive-type photoresist according to claim 12 or 13 which comprises the novolac resin and the photosensitive novolac resin, wherein the photosensitive novolac resin is obtained by reacting 10 to 60 parts by weight of a photosensitive compound with 100 parts by weight of the novolac resin, and wherein the amount corresponding to the photosensitive compound is in the range of 5 to 50 parts by weight with respect to 100 parts by weight of total amount of the novolac resin and the photosensitive novolac resin.

15. The positive-type photoresist according to any one of claims 10 to 13, wherein the photosensitive compound is 1,2-naphthoquinonediazidosulfonyl halide.

16. The positive-type photoresist according to claim 1 or 5, further comprising an anionic surfactant in an amount of 1 to 20 parts by weight with respect to 100 parts by weight of total amount of the novolac resin and a derivative of the novolac resin.

17. The positive-type photoresist according to claim 1 or 5, further comprising colloidal silica in an amount of 50 to 300 parts by weight with respect to 100 parts by weight of total amount of the novolac resin and a derivative of the novolac resin.

18. The positive-type photoresist according to claim 1 or 5, further comprising a viscosity-controlling agent in an amount of 100 to 700 parts by weight with respect to 100 parts by weight of total amount of the novolac resin and a derivative of the novolac resin.

19. A method for manufacturing a structure having a circuit formed using a resist pattern, comprising the steps of:
forming a resist film on a surface of a substrate by the use of the positive-type photoresist according to claim 1;
exposing the resist film to light and carrying out development;
forming a circuit by the use of the resist pattern; and
removing the resist film.

20. The method for manufacturing a structure having a circuit formed using a resist pattern according to claim 19, wherein development is carried out using as a developer, an aqueous alkali solution whose alkali substance content is 0.3 wt % or less, in the step of exposing the resist film to light and carrying out development.

21. A method for manufacturing a structure having a circuit formed using the resist pattern according to claim 19 or 20, wherein a resist film is removed with ozone water in the step of removing the resist film.
